(19) United States
(12) Patent Application Publication
(10) Pub. No.: US 2022/0368003 A1
(43) Pub. Date: Nov. 17, 2022

(54) ANTENNA MODULE AND MANUFACTURING METHOD THEREOF

(71) Applicant: MEDIATEK Inc., Hsin-Chu (TW)

(72) Inventors: Chung-Hsin CHIANG, Hsinchu City (TW); Yeh-Chun KAO, Hsinchu City (TW); Shih-Huang YEH, Hsinchu City (TW)

(21) Appl. No.: 17/721,701

(22) Filed: Apr. 15, 2022

Related U.S. Application Data
(60) Provisional application No. 63/188,511, filed on May 14, 2021.

(51) Int. Cl. H01Q 1/22; H01Q 1/38; H01Q 9/04; H01Q 5/378; H01Q 21/06

(52) U.S. Cl. CPC H01Q 1/2283; H01Q 1/38; H01Q 9/0485; H01Q 5/378; H01Q 21/065

(57) ABSTRACT

An antenna module includes a first dielectric layer, an antenna layer, an electronic element and a first antenna tuning element. The first dielectric layer has an first dielectric surface and a second dielectric surface opposite to the first dielectric surface in a thickness direction. The antenna layer is formed in the first dielectric layer or formed on the first dielectric surface. The electronic element is disposed near to the second dielectric surface than to the first dielectric surface. The first antenna tuning element is formed on one of the first dielectric surface and the second dielectric surface and connected to the antenna layer. The first antenna tuning element and the electronic element are disposed in the thickness direction.

This application claims the benefit of U.S. Provisional application Ser. No. 63/188,511, filed May 14, 2021, the disclosure of which is incorporated by reference herein in its entirety.

### FIELD OF THE INVENTION

The invention relates to an antenna module and a manufacturing method thereof, and more particularly to an antenna module including an antenna tuning element and a manufacturing method thereof.

### BACKGROUND OF THE INVENTION

Conventional antenna module includes an antenna and a substrate. The S-parameter of the antenna module depends on the structures of the antenna and the substrate. Thus, if the S-parameter of the antenna module is required to change, the structure of the antenna and/or the structure of the substrate must redesign accordingly.

### SUMMARY OF THE INVENTION

In an embodiment of the invention, an antenna module is provided. The antenna module includes a first dielectric layer, an antenna layer, an electronic element and a first antenna tuning element. The first dielectric layer has a first dielectric surface and a second dielectric surface opposite to the first dielectric surface in a thickness direction. The antenna layer is formed in the first dielectric layer or formed on the first dielectric surface. The electronic element is disposed near to the second dielectric surface than to the first dielectric surface. The first antenna tuning element is formed on one of the first dielectric surface and the second dielectric surface and connected to the antenna layer. The first antenna tuning element and the electronic element are disposed in the thickness direction.

In another embodiment of the invention, a manufacturing method of an antenna module is provided. The manufacturing method includes the following steps: providing a first dielectric layer, wherein first dielectric layer has a first dielectric surface and a second dielectric surface opposite to the first dielectric surface in a thickness direction; forming an antenna layer in the first dielectric layer or on the first dielectric surface than to the first dielectric surface; disposing the electronic element near the second dielectric surface; and forming a first antenna tuning element on one of the first dielectric surface and the second dielectric surface, wherein the first antenna tuning element is connected to the antenna layer, and the first antenna tuning element and the electronic element are disposed in the thickness direction.

Numerous objects, features and advantages of the invention will be readily apparent upon a reading of the following detailed description of embodiments of the invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the invention will become more readily apparent to those ordinarily skilled in the art after reviewing the following detailed description and accompanying drawings, in which:

FIG. 1A illustrates a diagram view of an antenna module according to an embodiment of the invention;

FIG. 1B illustrates a cross-sectional view of the antenna module of FIG. 1A along direction 1B-1B′;

FIG. 1C illustrates a diagram view of characteristic curve of S-parameter of the antenna module of FIG. 1B;

FIG. 1D illustrates a diagram view of the first antenna tuning element being connected with the first antenna layer of FIG. 1B;

FIG. 1E illustrates a diagram view of the first antenna tuning element being disposed on the first dielectric layer of FIG. 1B according another embodiment;

FIG. 2A illustrates a diagram view of an antenna module according to an embodiment of the invention;

FIG. 2B illustrates a diagram view of characteristic curve of S-parameter of the antenna module of FIG. 2A;

FIGS. 3A to 3D illustrate diagram views of the antenna modules to according to a number of embodiments of the invention;

FIG. 4 illustrates a diagram view of an antenna module according to another embodiment of the invention;

FIG. 5 illustrates a diagram view of an antenna module according to another embodiment of the invention;

FIG. 6 illustrates a diagram view of an antenna module according to another embodiment of the invention;

FIG. 7A illustrates a diagram view of an antenna module according to another embodiment of the invention;

FIG. 7B illustrates a diagram view of an antenna module according to another embodiment of the invention;

FIG. 8 illustrates a diagram view of an antenna module according to another embodiment of the invention;

FIG. 9 illustrates a diagram view of an antenna module according to another embodiment of the invention;

FIG. 10A illustrates a diagram view of an antenna module according to another embodiment of the invention;

FIG. 10B illustrates a diagram view of an antenna module according to another embodiment of the invention;

FIG. 11 illustrates a diagram view of an antenna module according to another embodiment of the invention;

FIG. 12 illustrates a diagram view of an antenna module according to another embodiment of the invention;

FIG. 13 illustrates a diagram view of an antenna module according to another embodiment of the invention; and

FIG. 14 illustrates manufacturing process of the antenna module of FIG. 1B.

### DETAILED DESCRIPTION OF PREFERRED EMBODIMENTS

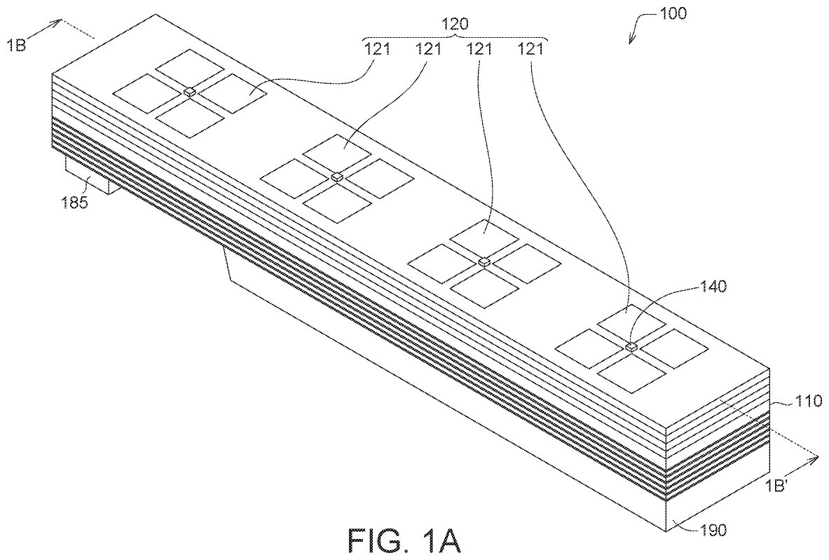

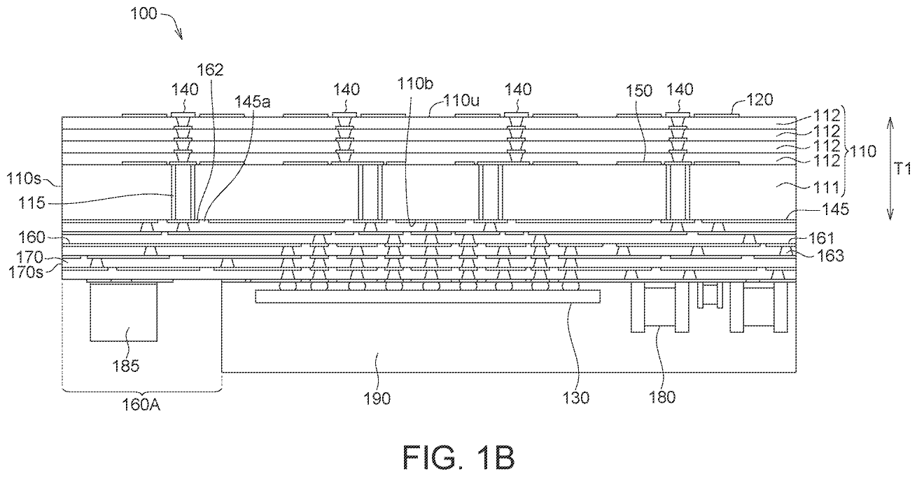

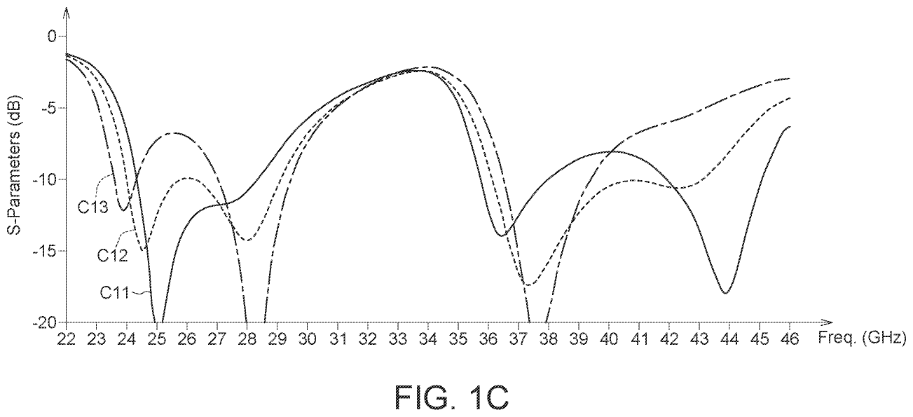

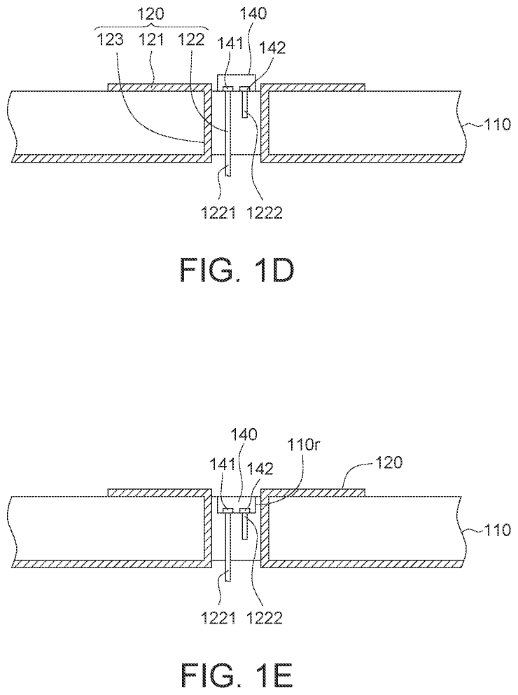

Referring to FIGS. 1A to 1E, FIG. 1A illustrates a diagram view of an antenna module 100 according to an embodiment of the invention, FIG. 1B illustrates a cross-sectional view of the antenna module 100 of FIG. 1A along direction 1B-1B′, FIG. 1C illustrates a diagram view of characteristic curve of S-parameter of the antenna module 100 of FIG. 1B, FIG. 1D illustrates a diagram view of the first antenna tuning element 140 being connected with the first antenna layer 120 of FIG. 1B, and FIG. 1E illustrates a diagram view of the first antenna tuning element 140 being disposed on the first dielectric layer 110 of FIG. 1B according another embodiment.

As shown in FIGS. 1A and 1B the antenna module 100 includes a first dielectric layer 110, at least one conductive via 115, a first antenna layer 120, at least one first electronic element 130, at least one first antenna tuning element 140, a grounding layer 145, a second antenna layer 150, at least one routing layer 160, at least one feeding pad 162 and at least one second dielectric layer 170, at least one second electronic component 180, a connector 185 and a molding compound 190.

As shown in FIGS. 1A and 1B, the first dielectric layer 110 has a first dielectric surface 110u and a second dielectric surface 110b opposite to the first dielectric surface 110u in a thickness direction T1. The first antenna layer 120 is formed in the first dielectric layer 110 or formed on the first dielectric surface 110u. The electronic element 130 is disposed near to the second dielectric surface 110b than to the first dielectric surface 110u. The first antenna tuning element 140 is formed on one of the first dielectric surface 110u and the second dielectric surface 110b and connected to the first antenna layer 120. The first antenna tuning element 140 and the electronic element 130 are disposed in the thickness direction T1.

As shown in FIGS. 1A and 1B, the first antenna tuning element 140 includes a passive component or an active component. Furthermore, the first antenna tuning element 140 includes, for example, an antenna aperture tuning element, an antenna impedance tuning element, a capacitor, an inductor, a varactor, a switch, a dielectric film, a dielectric cover, a dielectric load, a superstrate or a combination thereof.

As shown in FIG. 1C, the first antenna tuning element 140 being the inductor is taken for example. Curve C11 represents that the antenna module 100 omits the first antenna tuning element 140 (inductance value equals to zero), curve C12 represents that the first antenna tuning element 140 has inductance value of 80 pH, and curve C13 represents that the first antenna tuning element 140 has inductance value of 180 pH. The resonance frequency could change (or vary) with the inductance value of the first antenna tuning element 140. In other words, the first antenna tuning element 140 could adjust the resonance frequency without changing the design of other component such as the first dielectric layer 110, the first antenna layer 120 and/or the electronic element 130.

As shown in FIG. 1D, the first antenna layer 120 includes a main radiator 121, a feeding portion 122 and/or a ground via 123, wherein the first antenna tuning element 140 is connected to the feeding portion 122. In addition, the feeding portion 122 includes a first feeding line 1221 and a second feeding line 1222 separated from the first feeding line 1221, and the first antenna tuning element 140 includes two electrodes 141 and 142 electrically coupled to the first feeding line 1221 and the second feeding line 1222 respectively. According to another embodiment, the first antenna layer 120 may include a main radiator 121, a feeding portion 122, a ground via 123, and/or a parasitic radiator (not shown), wherein the first antenna tuning element 140 is connected to one of the main radiator 121, the feeding portion 122, the ground via 123 and/or the parasitic radiator (not shown).

As shown in FIG. 1E, the first antenna tuning element 140 could be embedded in the first dielectric layer 110. Furthermore, the first dielectric layer 110 has a recessed portion 110r within which the first antenna tuning element 140 is disposed. As a result, the first antenna tuning element 140 does not increase the thickness of the antenna module 100.

As shown in FIGS. 1A and 1B the first dielectric layer 110 could be single-layered structure or multi-layered structure. In the present embodiment, the first dielectric layer 110 includes a plurality of sub-dielectric layers, and at least two of the sub-dielectric layers are made by same or different materials. For example, the first dielectric layer 110 includes a first sub-dielectric layer 111 and a plurality of second sub-dielectric layers 112. In an embodiment, the first sub-dielectric layer 111 could be made of a material including FR4, FR5, BT, ceramic, glass, molding compound or liquid crystal polymer, and/or the second sub-dielectric layers 112 could be made of a material including FR4, FR5, BT, ceramic, glass, molding compound or liquid crystal polymer.

As shown in FIGS. 1A and 1B, at least one the conductive via 115 passes through the first dielectric layer 110 for electrically connecting the second antenna layer 150 with the routing layer 160. For example, the conductive via 115 passes through the first sub-dielectric layer 111. The conductive via 115 is electrically connected to, for example, feeding point. In another embodiment, the conductive via 115 could be omitted, and the signal transmitted by the first electronic component 130 could be coupled to the second antenna layer 150 by using technique of slot-coupled feed.

As shown in FIGS. 1A and 1D, in the present embodiment, the first antenna layer 120 and the second antenna layer 150 are separated from each other by the second sub-dielectric layers 112. The first antenna layer 120 is patterned antenna layer. For example, the first antenna layer 120 includes a plurality of main radiators 121 arranged in array of n×m, wherein n is integer equal to or greater than one, and m is integer equal to or greater than one.

As shown in FIGS. 1A and 1B, in the present embodiment, the grounding layer 145 is formed on the second dielectric surface 110b of the first dielectric layer 110 and extends to the first dielectric lateral surface 110s of the first dielectric layers 110. In another embodiment, the grounding layer 145 could not extend to the first dielectric lateral surface 110s. In addition, the grounding layer 145 has a plurality of opening 145a each receiving the corresponding feeding pad 162 and thus it could prevent the feeding pad 162 from contacting physical material of the grounding layer 145. The feeding pad 162 and the grounding layer 145 could be formed in, for example, the same layer. In addition, the grounding layer 145 is made of a metal including, for example, aluminum, copper, gold, silver, iron or a combination thereof.

As shown in FIGS. 1A and 1B, the second antenna layer 150 is formed within the first dielectric layer 110. In the present embodiment, the second antenna layer 150 is formed on one of the sub-dielectric layers, for example, an upper surface of the first sub-dielectric layer 111. In another embodiment, the second antenna layer 150 is formed on an upper surface of the second sub-dielectric layer 112.

As shown in FIGS. 1A and 1B, each routing layer 160 is, for example, a patterned layer. For example, each routing layer 160 includes at least one conductive trace 161, wherein the conductive trace 161 of one of the routing layers 160 could be electrically with the conductive trace 161 of another of the routing layers 160 through at least one conductive via 163.

As shown in FIGS. 1A and 1B, the second dielectric layers 170 are connected to the first dielectric layer 110. For example, one of the second dielectric layers 170 is directly connected to the first dielectric layer 110. A plurality of the second dielectric layers 170 are formed under the second dielectric surface 110b, and one of a plurality of the routing layers 160 is formed on a surface of the corresponding second dielectric layer 170. The routing layers 160 are separated by the corresponding second dielectric layer 170.

As shown in FIGS. 1A and 1B, the first electronic component 130 is disposed on and electrically connected to at least one of the routing layers 160. The first electronic component 130 is electrically connected to the feeding pad 162 through the routing layer 160. In an embodiment, the first electronic component 130 is, for example, RFIC (Radio Frequency Integrated Circuit); however, such exemplification is not meant to be for limiting.

As shown in FIGS. 1A and 1B the second electronic component 180 is disposed on and electrically connected to the routing layer 160. The second electronic component 180 is electrically connected to the first electronic component 130 through the routing layer 160. In an embodiment, the second electronic component 180 is, for example, passive component, for example, resistor, inductor and/or capacitor; however, such exemplification is not meant to be for limiting.

As shown in FIGS. 1A and 1B the connector 185 is disposed on and electrically connected to the routing layer 160. The connector 185 is electrically connected to the first electronic component 130 and/or the second electronic component 180 through the routing layer 160. the routing layer 160 exposes a portion 160A not coved by the molding compound 190, and the connector 185 is disposed on the portion 160A of the routing layer 160 and electrically connected with the conductive trace 161 of one of the routing layers 160. The antenna module 100 is electrically connected with an external component (not illustrated) through the connector 185, wherein the external component is, for example, a printed circuit board.

As shown in FIGS. 1A and 1B, the molding compound 190 is formed on the second dielectric layer 170 and the routing layer 160 and encapsulates the first electronic element 130 and the second electronic component 180. The molding compound 190 could be made of a material including, for example, a Novolac-based resin, an epoxy-based resin, a silicone-based resin, or another suitable encapsulant. Suitable fillers also can be included, such as powdered SiO2. The molding compound 190 can be applied using any of a number of molding techniques, such as compression molding, injection molding, or transfer molding.

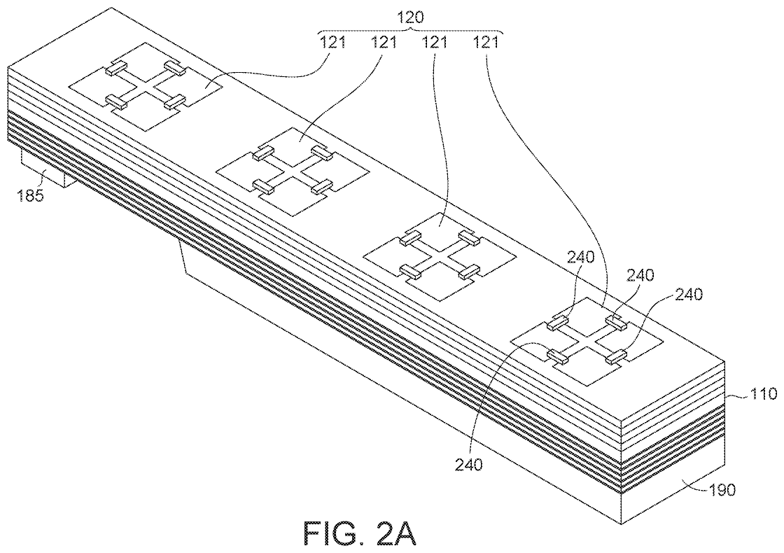

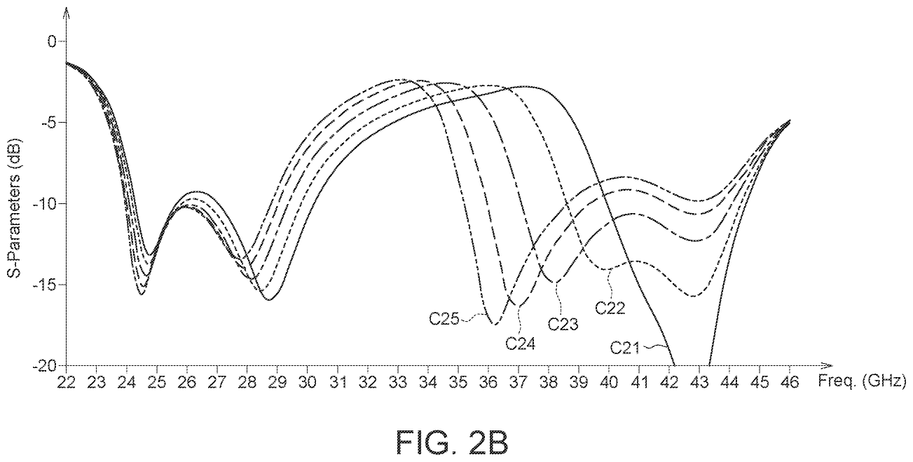

Referring to FIGS. 2A to 2B, FIG. 2A illustrates a diagram view of an antenna module 200 according to an embodiment of the invention, and FIG. 2B illustrates a diagram view of characteristic curve of S-parameter of the antenna module 200 of FIG. 2A.

As shown in FIG. 2A, the antenna module 200 includes the first dielectric layer 110, at least one conductive via 115 (not shown), the first antenna layer 120, at least one first electronic element 130 (not shown), at least one first antenna tuning element 240, the grounding layer 145 (not shown), the second antenna layer 150 (not shown), at least one routing layer 160 (not shown), at least one feeding pad 162 (not shown) and at least one second dielectric layer 170 (not shown), at least one second electronic component 180 (not shown), the connector 185 and the molding compound 190.

The first antenna tuning element 240 includes a passive component or an active component. Furthermore, the first antenna tuning element 240 includes, for example, an antenna aperture tuning element, an antenna impedance tuning element, a capacitor, an inductor, a varactor, a switch, a dielectric film, a dielectric cover, a dielectric load, a superstrate or a combination thereof.

As shown in FIG. 2B, the first antenna tuning element 240 being the capacitor is taken for example. Curve C21 represents that the antenna module 200 omits the first antenna tuning element 240 (capacitance value equals to zero), curve C22 represents that the first antenna tuning element 240 has capacitance value of 11 fF, curve C23 represents that the first antenna tuning element 240 has capacitance value of 23 fF, curve C24 represents that the first antenna tuning element 240 has capacitance value of 33 fF, and curve C25 represents that the first antenna tuning element 240 has capacitance value of 40 fF. As shown in FIG. 2B, the resonance frequency could change (or vary) with the capacitance value of the first antenna tuning element 240. In other words, the first antenna tuning element 240 could adjust the resonance frequency without changing the design of other component such as the first dielectric layer 110, the first antenna layer 120 and/or the electronic element 130.

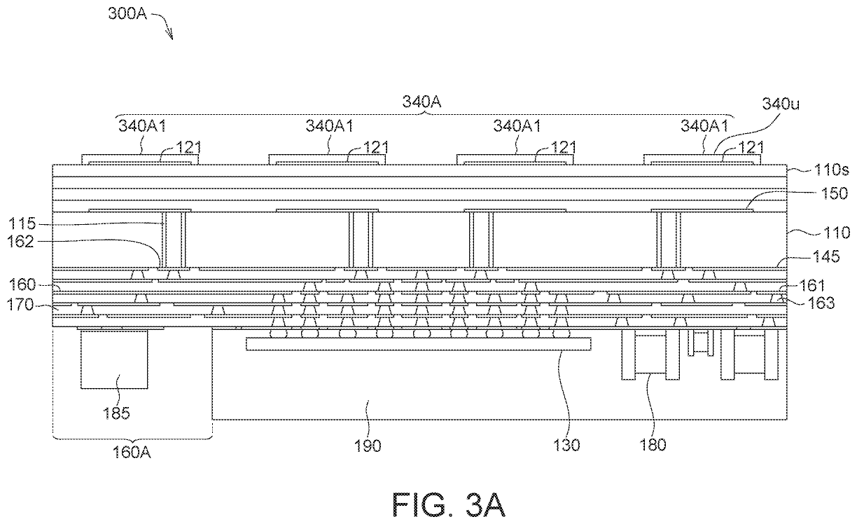

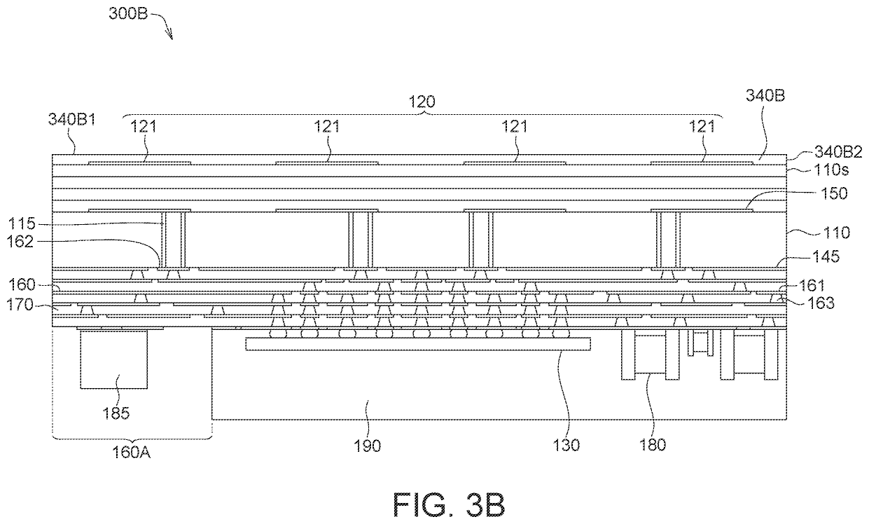

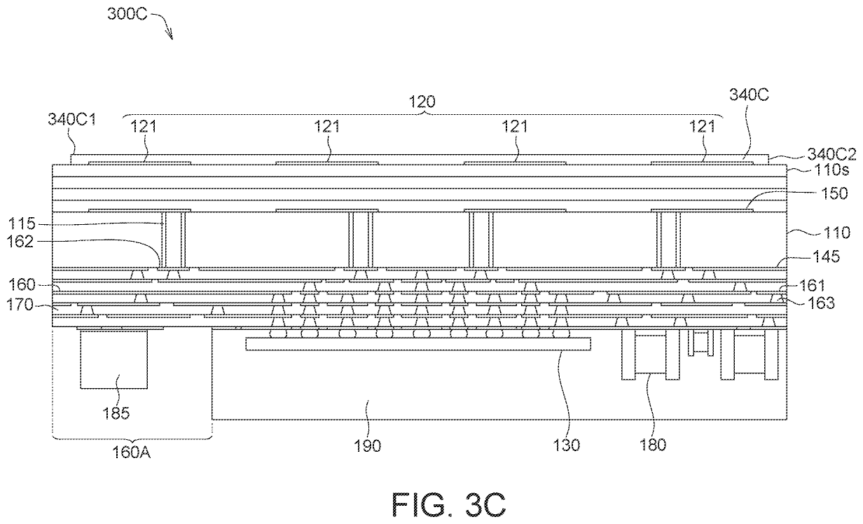

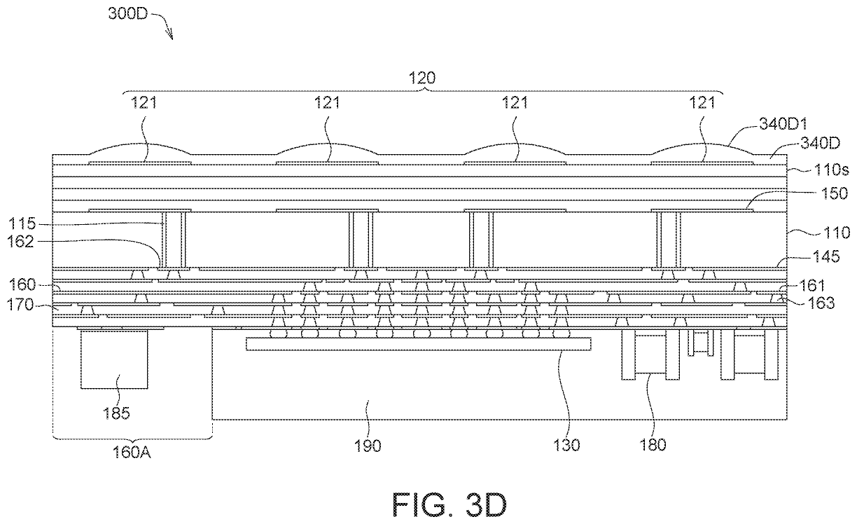

Referring to FIGS. 3A to 3D, FIGS. 3A to 3D illustrate diagram views of the antenna modules 300A to 300D according to a number of embodiments of the invention.

As shown in FIG. 3A, the antenna module 300A includes the first dielectric layer 110, at least one conductive via 115, the first antenna layer 120, at least one first electronic element 130, at least one first antenna tuning element 340A, the grounding layer 145, the second antenna layer 150, at least one routing layer 160, at least one feeding pad 162, at least one conductive via 163 and at least one second dielectric layer 170, at least one second electronic component 180, the connector 185 and the molding compound 190.

The antenna module 300A includes the features the same as or similar to that of the antenna module 100 expect that the first antenna tuning element 340A has structure different from that of the first antenna tuning element 140. For example, the first antenna tuning element 340 is a dielectric material covering the antenna layer 120. Furthermore, the first antenna tuning element 340A includes a number of antenna elements 340A1, and the antenna layer 120 includes a number of main radiators 121, wherein each dielectric element 340A1 covers the corresponding main radiator 121 and has an upper surface 340u which may be flat surface or non-flat surface, for example, curved surface or stepped surface.

As shown in FIG. 3B, the antenna module 3003 includes the first dielectric layer 110, at least one conductive via 115, the first antenna layer 120, at least one first electronic element 130, at least one first antenna tuning element 340B, the grounding layer 145, the second antenna layer 150, at least one routing layer 160, at least one feeding pad 162, at least one conductive via 163 and at least one second dielectric layer 170, at least one second electronic component 180, the connector 185 and the molding compound 190.

The antenna module 300B includes the features the same as or similar to that of the antenna module 300A expect that the first antenna tuning element 340B has structure different from that of the first antenna tuning element 340A. For example, the first antenna tuning element 340B is one dielectric material covering the antenna layer 120. Furthermore, the dielectric element 340B covers all of the antenna elements 121 and has an upper surface 340B1 which is flat surface and a lateral surface 340B2 which is flush with a lateral surface 110s of the first dielectric layer 110.

As shown in FIG. 30, the antenna module 300C includes the first dielectric layer 110, at least one conductive via 115, the first antenna layer 120, at least one first electronic element 130, at least one first antenna tuning element 340C, the grounding layer 145, the second antenna layer 150, at least one routing layer 160, at least one feeding pad 162, at least one conductive via 163 and at least one second dielectric layer 170, at least one second electronic component 180, the connector 185 and the molding compound 190.

The antenna module 300C includes the features the same as or similar to that of the antenna module 300B expect that the first antenna tuning element 340C has structure different from that of the first antenna tuning element 340B. For example, the first antenna tuning element 340C has a lateral surface 340C2 not extending to the lateral surface 110s of the first dielectric layer 110.

As shown in FIG. 30, the antenna module 300D includes the first dielectric layer 110, at least one conductive via 115, the first antenna layer 120, at least one first electronic element 130, at least one first antenna tuning element 340D, the grounding layer 145, the second antenna layer 150, at least one routing layer 160, at least one feeding pad 162, at least one conductive via 163 and at least one second dielectric layer 170, at least one second electronic component 180, the connector 185 and the molding compound 190.

The antenna module 300D includes the features the same as or similar to that of the antenna module 300B expect that the first antenna tuning element 340D has structure different from that of the first antenna tuning element 340B. For example, the first antenna tuning element 340D has an upper surface 340D1 which is curved surface.

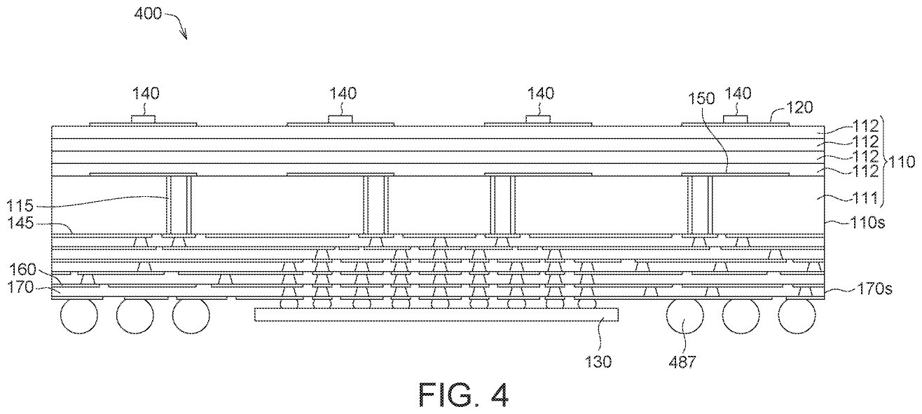

Referring to FIG. 4, FIG. 4 illustrates a diagram view of an antenna module 400 according to another embodiment of the invention. The antenna module 400 includes the first dielectric layer 110, at least one conductive via 115, the first antenna layer 120, at least one first electronic element 130, at least one first antenna tuning element 140, the grounding layer 145, the second antenna layer 150, at least one routing layer 160 and at least one second dielectric layer 170, at least one second electronic component 180 (selectively, not shown) and at least one contact 487.

As illustrated in FIG. 4, the contact 487 is, for example, solder ball, solder paste, conductive pillar, etc. A plurality of the contacts 387 is disposed on the routing layer 160. The antenna module 400 is electrically connected to an external component through the contacts 487, wherein the external component is, for example, a printed circuit board. In the present embodiment, the first electronic component 130 and the contacts 487 are disposed on the same side of the routing layer 160. For example, the contacts 487 and the first electronic component 130 are disposed on the bottommost routing layer 160. In addition, one of the routing layers 160 is electrically grounded through one of the contacts 487, so that the grounding layer 145 is electrically grounded through the routing layer 160 and one of the contacts 487.

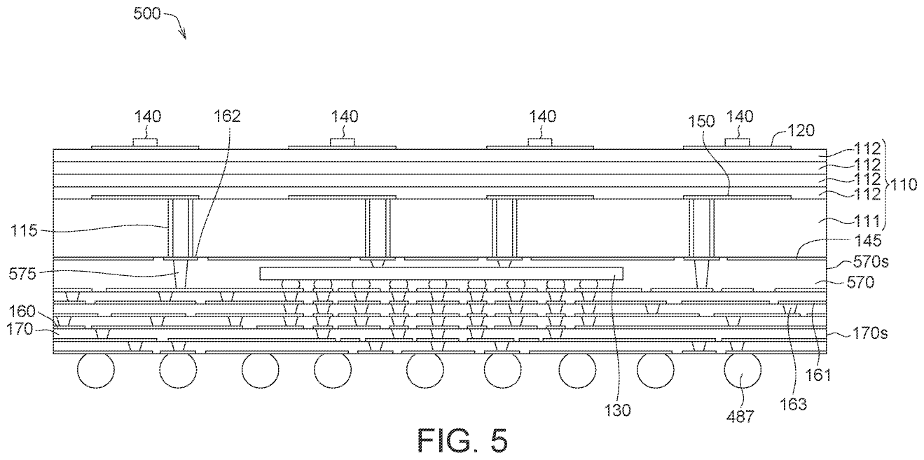

Referring to FIG. 5, FIG. 5 illustrates a diagram view of an antenna module 500 according to another embodiment of the invention. The antenna module 500 includes the first dielectric layer 110, at least one conductive via 115, the first antenna layer 120, at least one first electronic element 130, at least one first antenna tuning element 140, the grounding layer 145, the second antenna layer 150, at least one routing layer 160, at least one feeding pad 162 and at least one second dielectric layer 170, at least one second electronic component 180 (not illustrated, selectively), at least one contact 487, a third dielectric layer 570 and at least one conductive via 575.

As illustrated in FIG. 5, the first electronic component 130 and the contact 487 are disposed on opposite two sides of the routing layer 160. The third dielectric layer 570 is disposed between the routing layer 160 and the first dielectric layer 110 and encapsulating the first electronic component 130. In an embodiment, the third dielectric layer 570 could be made of a material including FR4, FR5, BT or molding compound. At least one conductive via 575 passes through the third dielectric layer 570 and electrically connects one of the routing layers 160 and the conductive via 115.

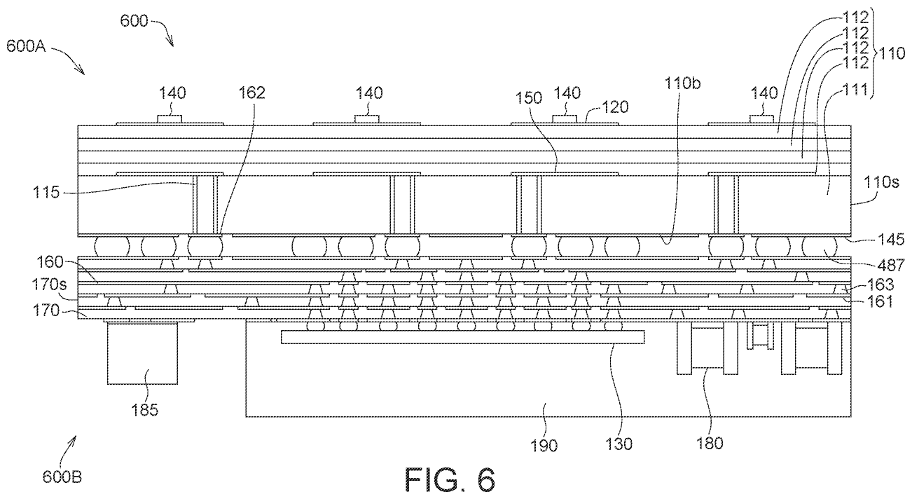

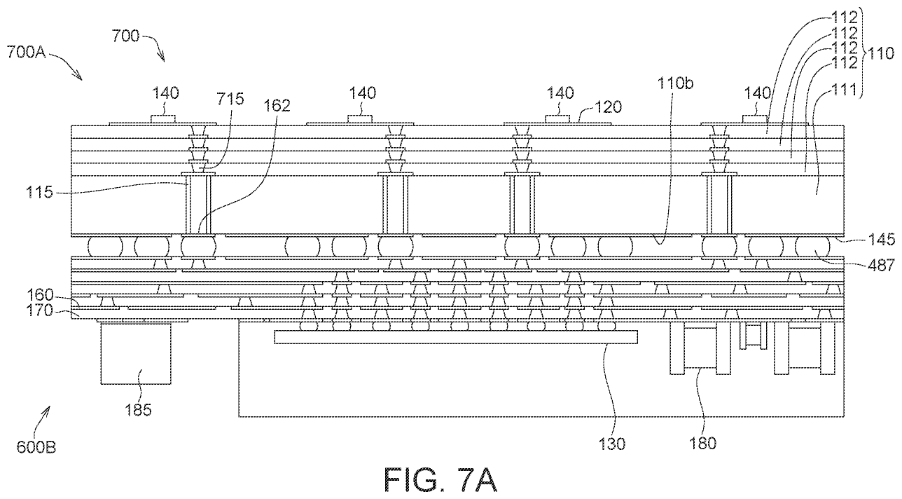

Referring to FIG. 6, FIG. 6 illustrates a diagram view of an antenna module 500 according to another embodiment of the invention. The antenna module 600 includes the first dielectric layer 110, at least one conductive via 115 the first antenna layer 120, at least one first electronic element 130, at least one first antenna tuning element 140, the grounding layer 145, the second antenna layer 150, at least one routing layer 160 and at least one second dielectric layer 170, at least one second electronic component 180, the connector 185, the molding compound 190 and at least one contact 487.

In the present embodiment, the first dielectric layer 110, at least one conductive via 115, the first antenna layer 120, the first antenna tuning element 140, the grounding layer 145 and the second antenna layer 150 are formed in/on a substrate 600A, and at least one routing layer 160, at least one dielectric layer 170, at least one first electronic component 130, at least one second electronic component 180, the connector 185 and the molding compound 190 form a package 600B, wherein the substrate 600A and the package 600B are disposed oppositely and electrically connected by the contact 487. According to another embodiment, the substrate 600A may have another routing layer (not shown) between the second dielectric surface 110b of the first dielectric layer 110 and the grounding layer 145.

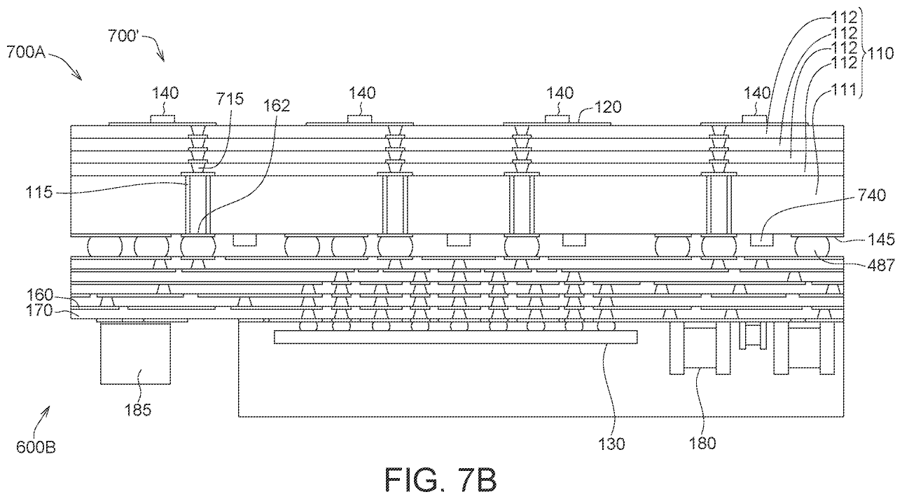

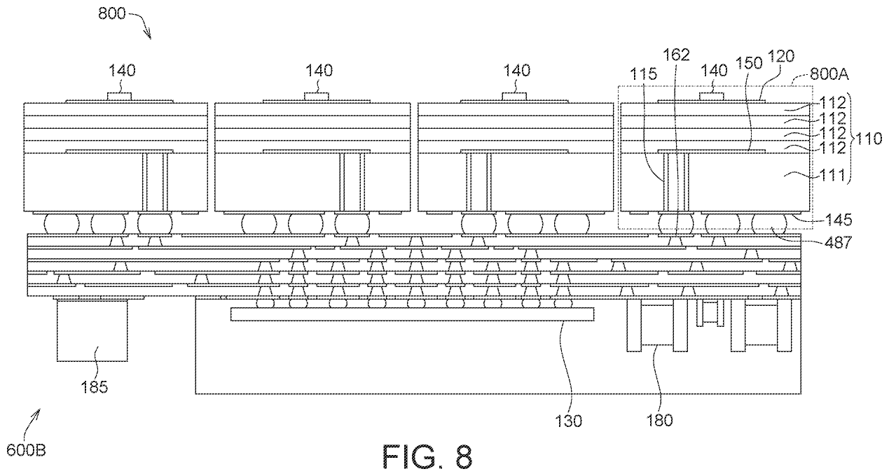

Referring to FIG. 7A, FIG. 7A illustrates a diagram view of an antenna module 700 according to another embodiment of the invention. The antenna module 700 includes the first dielectric layer 110, at least one conductive via 115, the first antenna layer 120, at least one first electronic element 130, at least one first antenna tuning element 140, the grounding layer 145, at least one routing layer 160 and at least one second dielectric layer 170, at least one second electronic component 180, the connector 185, the molding compound 190, at least one contact 487 and at least one conductive via 715.

In the present embodiment, as illustrated in FIG. 7A, the conductive via 115 and a plurality of the conductive via 715 together pass through the first dielectric layer 110 and electrically connecting the first antenna layer 120 and the feeding pad 162 of one of the routing layers 160 through the contact 487.

In the present embodiment, the first dielectric layer 110, at least one conductive via 115 the first antenna layer 120, the grounding layer 145 and at least one conductive via 715 are formed in/on a substrate 700A, and at least one routing layer 160, at least one dielectric layer 170, at least one first electronic component 130, at least one second electronic component 180, the connector 185 and the molding compound 190 form the package 600B, wherein the substrate 700A and the package 600B are disposed oppositely and electrically connected by the contact 487, According to another embodiment, the substrate 700A may have another routing layer (not shown) between the second dielectric surface 110b of the first dielectric layer 110 and the grounding layer 145.

Referring to FIG. 7B, FIG. 7B illustrates a diagram view of an antenna module 700′ according to another embodiment of the invention. The antenna module 700′ includes the first dielectric layer 110, at least one conductive via 115, the first antenna layer 120, at least one first electronic element 130, at least one first antenna tuning element 140, the grounding layer 145, at least one routing layer 160 and at least one second dielectric layer 170, at least one second electronic component 180, the connector 185, the molding compound 190, at least one contact 487, at least one conductive via 715 and at least one second antenna tuning element 740.

The antenna module 700′ includes the features the same as or similar to that of the antenna module 700 expect that the antenna module 700′ further includes the second antenna tuning element 740 formed on the second dielectric surface 110b of the first dielectric layer 110. The type of the second antenna tuning element 740 is same as or similar to that of the first antenna tuning element 740.

Referring to FIG. 8, FIG. 8 illustrates a diagram view of an antenna module 800 according to another embodiment of the invention. The antenna module 800 includes a plurality of antenna units 800A, the second substrate 600B and at least one contact 487, wherein the antenna units 800A are spaced from each other. For example, each antenna unit 800A includes the first dielectric layer 110, at least one conductive via 115, the first antenna layer 120, the grounding layer 145 and the first antenna tuning element 140. Each antenna unit 800A is electrically connected with the second substrate 600B by at least one contact 487. According to another embodiment, the substrate 800A may have another routing layer (not shown) between the second dielectric surface 110b of the first dielectric layer 110 and the grounding layer 145.

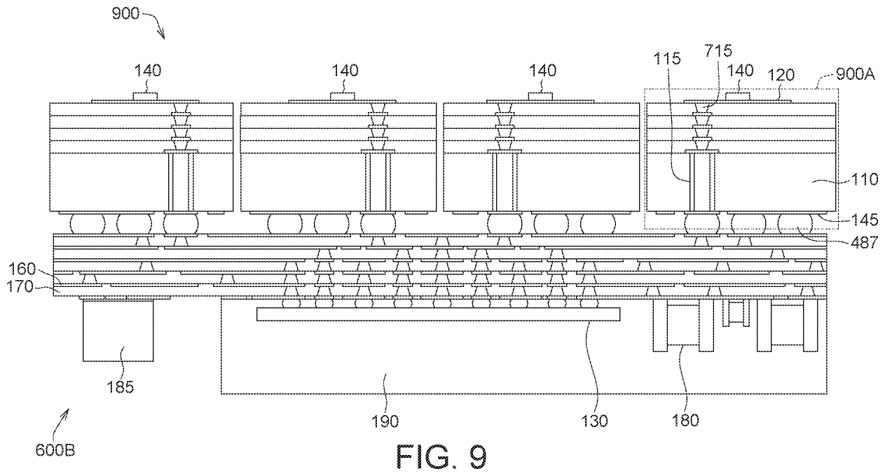

Referring to FIG. 9, FIG. 9 illustrates a diagram view of an antenna module 900 according to another embodiment of the invention. The antenna module 900 includes a plurality of antenna units 900A, the second substrate 600B and at least one contact 487, wherein the antenna units 900A are spaced from each other, and each antenna unit 900A includes the features similar to or the same as that of the substrate 700A. For example, each antenna unit 900A includes the first dielectric layer 110, at least one conductive via 115, the first antenna layer 120, the grounding layer 145 and at least one conductive via 715. Each antenna unit 900A is electrically connected with the second substrate 600B by at least one contact 487.

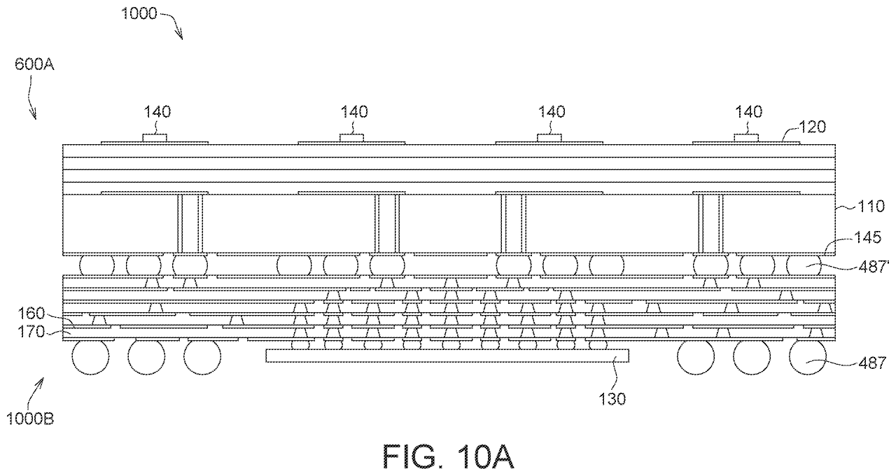

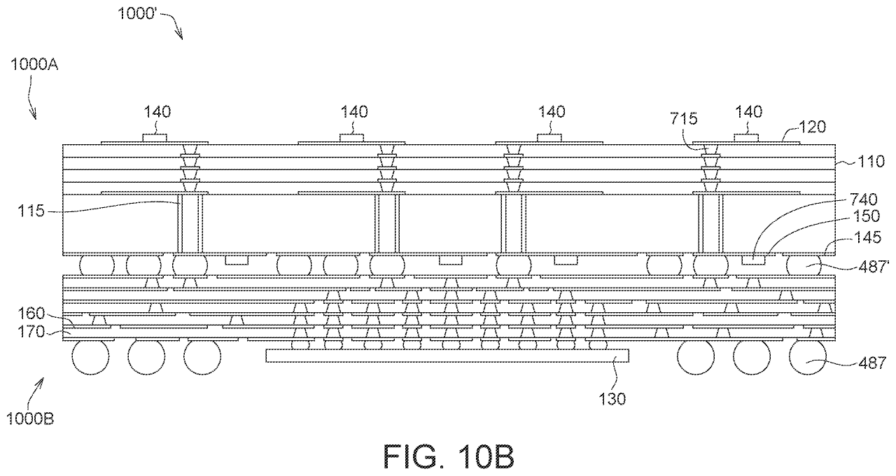

Referring to FIG. 10A, FIG. 10A illustrates a diagram view of an antenna module 1000 according to another embodiment of the invention. The antenna module 1000 includes the substrate 600A, a package 1000B and at least one contact 487′, wherein the package 1000B includes at least one routing layer 160 and at least one dielectric layer 170, at least one first electronic component 130, at least one second electronic component 180 (not illustrated, selectively) and at least one contact 487. The substrate 600A is electrically connected with the package 1000B by at least one contact 487′.

Referring to FIG. 10B, FIG. 10B illustrates a diagram view of an antenna module 1000′ according to another embodiment of the invention. The antenna module 1000′ includes the substrate 1000A, the package 1000B and at least one contact 487′, wherein the substrate 1000A includes the first dielectric layer 110, at least one conductive via 115, the first antenna layer 120, the first antenna tuning element 140 and a plurality of the conductive via 715, and the package 1000B includes at least one routing layer 160 and at least one dielectric layer 170, at least one first electronic component 130, at least one second electronic component 180 (not illustrated, selectively) and at least one contact 487, The substrate 1000A is electrically connected with the package 1000B by at least one contact 487′.

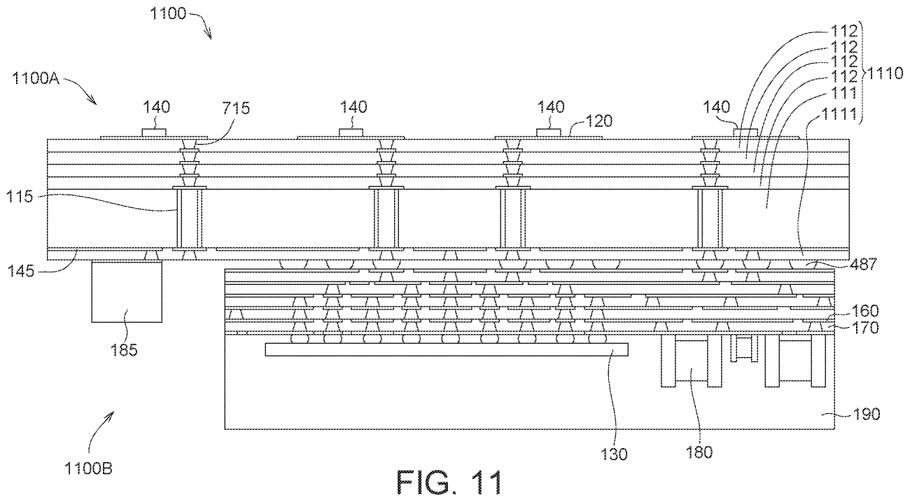

Referring to FIG. 11, FIG. 11 illustrates a diagram view of an antenna module 1100 according to another embodiment of the invention. The antenna module 1100 includes a first dielectric layer 1110, at least one conductive via 115, the first antenna layer 120, at least one first electronic component 130, the grounding layer 145, at least one routing layer 160, at least one dielectric layer 170, at least one second electronic component 180, the connector 185, the molding compound 190, at least one contact 487 and at least one conductive via 715.

The first dielectric layer 1110, at least one conductive via 115, the first antenna layer 120, the grounding layer 145 and at least one conductive via 715 form a substrate 1100A, and at least one routing layer 160, at least one dielectric layer 170, at least one first electronic component 130, at least one second electronic component 180 and the molding compound 190 form a package 1100B. The package 1100B and the substrate 1100A are electrically connected by at least one contact 487.

In the present embodiment, the connector 185 is disposed on one of the layer of the first dielectric layer 1110, for example, the first sub-dielectric layer 1111. The connector 185 and the package 1100B are disposed on the same side of the substrate 1100A.

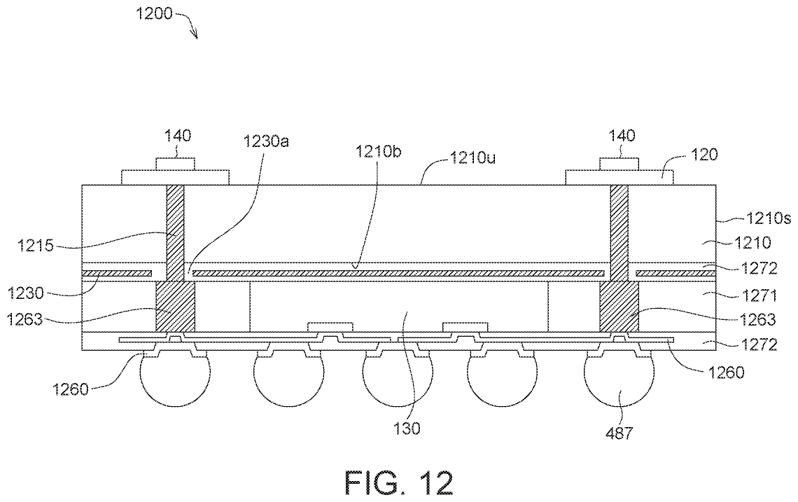

Referring to FIG. 12, FIG. 12 illustrates a diagram view of an antenna module 1200 according to another embodiment of the invention. The antenna module 1200 includes at least one first electronic component 130, at least one first antenna tuning element 140, a first dielectric layer 1210, at least one conductive via 1215, a first antenna layer 1220, a grounding layer 1230, at least one routing layer 1260, at least one conductive via 1263 and a plurality of dielectric layers 1271 and 1272 and at least one contact 487.

The first dielectric layer 1210 has a first dielectric surface 1210u and a second dielectric surface 1210b opposite to the first dielectric surface 1210u in a thickness direction. The first antenna layer 120 is formed in the first dielectric layer 1210 or formed on the first dielectric surface 1210u. The electronic element 130 is disposed near to the second dielectric surface 1210b than to the first dielectric surface 1210u. The first antenna tuning element 140 is formed on one of the first dielectric surface 1210u and the second dielectric surface 1210b and connected to the first antenna layer 120. The first antenna tuning element 140 and the electronic element 130 are disposed in the thickness direction.

In the present embodiment, the first dielectric layer 1210 is, for example, single-layered structure. The dielectric layer 1271 is made of a material same or different from that of the dielectric layer 1272. The grounding layer 1230 is embedded in one of the dielectric layers 1272. The grounding layer 1230 has a plurality of opening 1230a each allowing the corresponding conductive via 1215 to pass through. The first electronic component 130 is electrically connected to the first antenna layer 1220 through the routing layers 1260, the conductive via 1263 and the conductive via 1215. In an embodiment, the first electronic component 130 is, for example, RFIC (Radio Frequency Integrated Circuit); however, such exemplification is not meant to be for limiting. The contact 487 is, for example, solder ball, solder paste, conductive pillar, etc. A plurality of the contacts 487 is disposed on the routing layer 1260.

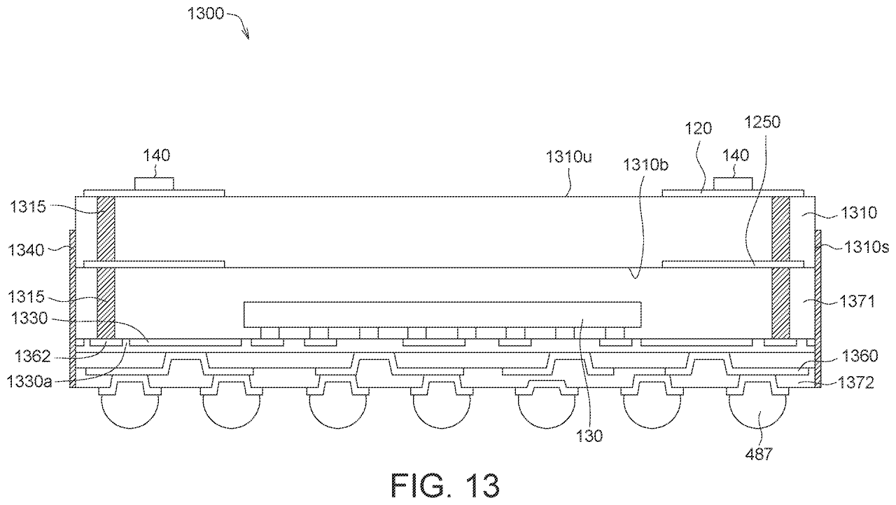

Referring to FIG. 13, FIG. 13 illustrates a diagram view of an antenna module 1300 according to another embodiment of the invention. The antenna module 1300 includes a first dielectric layer 1310, at least one conductive via 1315, a first antenna layer 1320, a grounding layer 1330, a conductive layer 1340, at least one routing layer 1360, at least one conductive via 1315 and a plurality of dielectric layers 1371 and 1372, at least one first electronic component 130 and at least one contact 487.

The first dielectric layer 1310 has a first dielectric surface 1310u and a second dielectric surface 1310b opposite to the first dielectric surface 1310u in a thickness direction. The first antenna layer 120 is formed in the first dielectric layer 1310 or formed on the first dielectric surface 1310u. The electronic element 130 is disposed near to the second dielectric surface 1310b than to the first dielectric surface 1310u. The first antenna tuning element 140 is formed on one of the first dielectric surface 1310u and the second dielectric surface 1310b and connected to the first antenna layer 120. The first antenna tuning element 140 and the electronic element 130 are disposed in the thickness direction.

In the present embodiment, the dielectric layer 1371 is made of a material different from that of the dielectric layer 1372. The grounding layer 1330 is embedded in one of the dielectric layers 1372. The grounding layer 1330 has a plurality of opening 1330a each receiving the corresponding feeding pad 1362 and thus it could prevent the feeding pad 1362 from contacting physical material of the grounding layer 1330. The first electronic component 130 is electrically connected to the first antenna layer 1220 through the routing layers 1360, the conductive via 1362, the conductive via 1315 and the conductive via 1315.

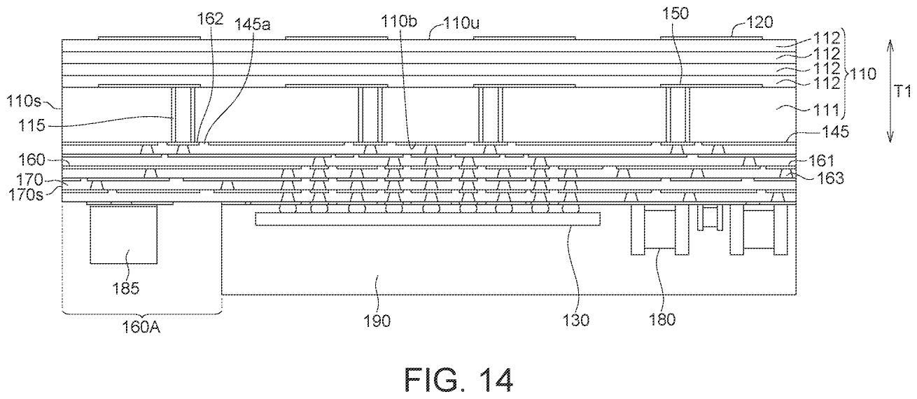

Referring to FIGS. 14, FIG. 14 illustrates manufacturing process of the antenna module 100 of FIG. 1B.

As illustrated in FIG. 14, the first dielectric layer 110 is provided, wherein first dielectric layer 110 has the first dielectric surface 110u and the second dielectric surface opposite to the first dielectric surface 110u in the thickness direction T1. Then, the first antenna layer 120 is formed in the first dielectric layer 110 or on the first dielectric surface 110u than to the first dielectric surface 110u. Then, the electronic element 130 is disposed near the second dielectric surface 110b. Then, as shown in FIG. 1B, the first antenna tuning element 140 is disposed on one of the first dielectric surface 110u and the second dielectric surface 110b, wherein the first antenna tuning element 140 is connected to the antenna layer 120, and the first antenna tuning element 140 and the electronic element 130 are disposed in the thickness direction T1.

The manufacturing method of other antenna modules in other embodiments is the same as or similar to that of the antenna module 100. Furthermore, after the first dielectric layer and/or the first antenna layer is formed, at least one the first antenna tuning element is formed on the first dielectric layer.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An antenna module, comprising:
a first dielectric layer having an first dielectric surface and a second dielectric surface opposite to the first dielectric surface in a thickness direction;
an antenna layer formed in the first dielectric layer or formed on the first dielectric surface;
an electronic element disposed near to the second dielectric surface than to the first dielectric surface; and
a first antenna tuning element formed on one of the first dielectric surface and the second dielectric surface and connected to the antenna layer;
wherein the first antenna tuning element and the electronic element are disposed in the thickness direction.

2. The antenna module as claimed in claim 1, wherein the first antenna tuning element is a passive component or an active component.

3. The antenna module as claimed in claim 1, wherein the antenna layer comprises a main radiator, a feeding portion and/or a parasitic radiator, and the first antenna tuning element is connected to one of the main radiator, the feeding portion and the parasitic radiator.

4. The antenna module as claimed in claim 3, wherein the feeding portion comprises a first feeding line and a second feeding line separated from the first feeding line, and the first antenna tuning element comprises two electrodes electrically coupled to the first feeding line and the second feeding line respectively.

5. The antenna module as claimed in claim 1, wherein the first antenna tuning element is a dielectric material covering the antenna layer.

6. The antenna module as claimed in claim 5, wherein the antenna layer comprises a plurality of antenna elements, the dielectric material comprises a plurality of dielectric elements, and each dielectric element covers the corresponding antenna element.

7. The antenna module as claimed in claim 5, wherein the antenna layer comprises a plurality of antenna elements, the dielectric material covers all of the antenna elements.

8. The antenna module as claimed in claim 5, wherein the dielectric material has an upper surface which is flat surface, stepped surface or curved surface.

9. The antenna module as claimed in claim 1, further comprises:
a second dielectric layer connected to the first dielectric layer;
a routing layer formed on a surface of the second dielectric layer; and
the electronic element.

10. The antenna module as claimed in claim 9, wherein the first dielectric layer comprises a plurality of sub-dielectric layers, and at least two of the sub-dielectric layers are made by same or different materials.

11. The antenna module as claimed in claim 9, wherein the second dielectric layer is directly connected to the first dielectric layer.

12. The antenna module as claimed in claim 1, further comprises:
a second dielectric layer separated from the first dielectric layer;
a routing layer formed on a surface of the second dielectric layer;
a contact formed between the first dielectric layer and the second dielectric layer; and
the electronic element.

13. The antenna module as claimed in claim 1, further comprises:
a plurality of antenna units each comprising the first dielectric layer and the antenna layer, wherein the antenna units are spaced from each other;
a second dielectric layer connected to the antenna units;
a plurality of contacts each formed between the second dielectric layer and the corresponding antenna unit; and
the electronic element.

14. The antenna module as claimed in claim 1, further comprises:
a second dielectric layer connected to the first dielectric layer;
a routing layer formed a surface of the second dielectric layer; and
a contact formed below the second dielectric layer and electrically connected to the routing layer;
wherein the electronic element is formed below the second dielectric layer and electrically connected to the routing layer.

15. The antenna module as claimed in claim 1, further comprises:
a second dielectric layer separated from the first dielectric layer;
a routing layer formed a surface of the second dielectric layer; and
a contact formed between the first dielectric layer and the second dielectric layer;
wherein the electronic element is formed below the second dielectric layer and electrically connected to the routing layer.

16. The antenna module as claimed in claim 1, further comprises:
a plurality of antenna units each comprising the first dielectric layer and the antenna layer, wherein the antenna units are spaced from each other;
a second dielectric layer connected to the antenna units: and
a plurality of contacts each formed between the second dielectric layer and the corresponding antenna unit;
wherein the electronic element is formed below the second dielectric layer and electrically connected to the routing layer.

17. The antenna module as claimed in claim 1, further comprises:
a second antenna tuning element;
wherein the first antenna tuning element and the second antenna tuning element are formed on the first dielectric surface and the second dielectric surface respectively.

18. The antenna module as claimed in claim 1, further comprises:
a second dielectric layer: and
a third dielectric layer formed between the first dielectric layer and the second dielectric layer and encapsulating the electronic component which is disposed between the first dielectric layer and the second dielectric layer.

19. The antenna module as claimed in claim 1, wherein the first dielectric layer has a recessed portion within which the first antenna tuning element is disposed.

20. A manufacturing method of an antenna module, comprising:
providing a first dielectric layer, wherein first dielectric layer has a first dielectric surface and a second dielectric surface opposite to the first dielectric surface in a thickness direction;
forming an antenna layer in the first dielectric layer or on the first dielectric surface;
disposing the electronic element near the second dielectric surface; and
forming a first antenna tuning element on one of the first dielectric surface and the second dielectric surface, wherein the first antenna tuning element is connected to the antenna layer, and the first antenna tuning element and the electronic element are disposed in the thickness direction.
